(19) United States
(12) Patent Application Publication
(10) Pub. No.: US 2007/0160244 A1
(43) Pub. Date: Jul. 12, 2007

(54) Pillow sham incorporating an amplifier and speakers

(76) Inventor: Nathan Hedaya, New York, NY (US)

Correspondence Address: GORDON & JACOBSON, P.C., 60 LONG RIDGE ROAD, SUITE 407, STAMFORD, CT, 06902, US

(21) Appl. No.: 11/327,995

(22) Filed: Jan. 9, 2006

(51) Int. Cl. H04R 9/06

(52) U.S. Cl. 381/333; 381/334

(57) ABSTRACT

A pillow sham is provided with spaced apart stereo speakers, an amplifier, and a pocket adapted to receive a personal stereo such as an MP3 player. The speakers are contained in a compartment which runs substantially the entire width of the pillow sham and the amplifier is contained in a compartment mounted below one of the speakers. The compartments are preferably provided with structure which allows them to be removed from the pillow sham so that the pillow sham can be washed. The amplifier is typically connected to an eighth-inch stereo mini-plug by a stereo cable which extends out of the amplifier compartment, through a front surface of the pillow sham, and into a pocket on the outside of the pillow sham.

### BACKGROUND OF THE INVENTION

1. Field of the Invention

This invention relates broadly to a bedding accessory. More particularly, this invention relates to an amplifier and speakers removably incorporated in a pillow sham.

2. State of the Art

Many people enjoy listening to music in bed, either prior to falling asleep or after awakening. This desire is often served by bedside music appliances such as clock radios, CD players, etc. Although some of these music appliances may include stereo speakers, they are usually mounted close together in the same enclosure which is placed on a nightstand. Thus, both stereo channels are heard by one ear (i.e., the ear closest the nightstand) and the stereo effect is diminished.

One of the most significant innovations in audio technology was the personal stereo, in particular the Sony Walkman which appeared in the late 1970s and was promptly copied by almost every audio manufacturer throughout the world. More recently, digital technology has replaced the traditional personal stereo with the MP3 Player. The extremely successful Apple iPod is ubiquitous in most major cities of the world and has radically changed the way people acquire and listen to audio. Through the use of many popular accessories, the iPod has become not only a personal stereo, but a car stereo and a home or office stereo.

### SUMMARY OF THE INVENTION

It is therefore an object of the invention to provide an apparatus for adapting a personal stereo for use in a pillow sham.

It is another object of the invention to provide an apparatus which creates a quality stereo sound in a pillow sham.

In accord with these objects, which will be discussed in detail below, a pillow sham is provided with spaced apart stereo speakers, an amplifier, and a pocket adapted to receive a personal stereo, preferably an ipod or the like. The speakers are contained in a compartment which runs substantially the entire length of the pillow sham and the amplifier is contained in a compartment mounted below one of the speakers. The speaker and amplifier compartment(s) are preferably removably held in place inside the pillow sham with VELCRO, and the compartment(s) are optionally provided with means which allow them to be opened and closed. The compartments may be removed so that the pillow sham can be washed. In addition, at least the amplifier, and optionally the amplifier and speakers may be removed from their compartments. The amplifier is connected to an eighth-inch stereo mini-plug by a stereo cable which extends out of the amplifier compartment into a pocket on the outside of the pillow sham. The pocket is dimensioned to receive an iPod or similar device. It will be appreciated that the speakers are spaced sufficiently apart to achieve a true stereo effect.

Additional objects and advantages of the invention will become apparent to those skilled in the art upon reference to the detailed description taken in conjunction with the provided figures.

### BRIEF DESCRIPTION OF THE DRAWINGS

FIG. 1 is a plan view of the top side of a pillow sham according to the invention showing the location of the pocket;

FIG. 2 is a plan view of the bottom side according to the invention with the speaker and amplifier compartment opened; and

FIG. 3 is a partially cut away plan view of the removable speaker and amplifier compartments according to the invention.

### DETAILED DESCRIPTION OF THE PREFERRED EMBODIMENT

Turning now to the Figures generally, a pillow sham 10 according to the invention is preferably made of cloth and has an upper edge 12, a lower edge 14, two side edges 16 and 18, a top surface 20, and a bottom surface 22. The top and/or bottom surfaces form an enclosure and are optionally provided with designs and graphics (not shown). The edges are generally straight, although they need not be. A seam 24 may be arranged parallel to the edges for a decorative effect. The pillow sham 10 may be of different dimensions. One exemplary embodiment is 30 inches by 24 inches.

The top surface 20 is provided with a pocket 26 near the seam close to the bottom edge 14. The pocket may be of different dimensions and is preferably dimensioned to accommodate an MP3 player such as an Apple ipod. One exemplary embodiment is a pocket of dimensions 4 inches by 5 inches. The bottom surface 22 of the pillow sham 10 is provided overlapping fabric portions 22a, 22b forming a slot or opening 28 which extends from the seam near the upper edge 12 to the seam near the lower edge 14. The slot 28 allows access to the interior (enclosure) of the pillow sham so that a pillow may be placed therein.

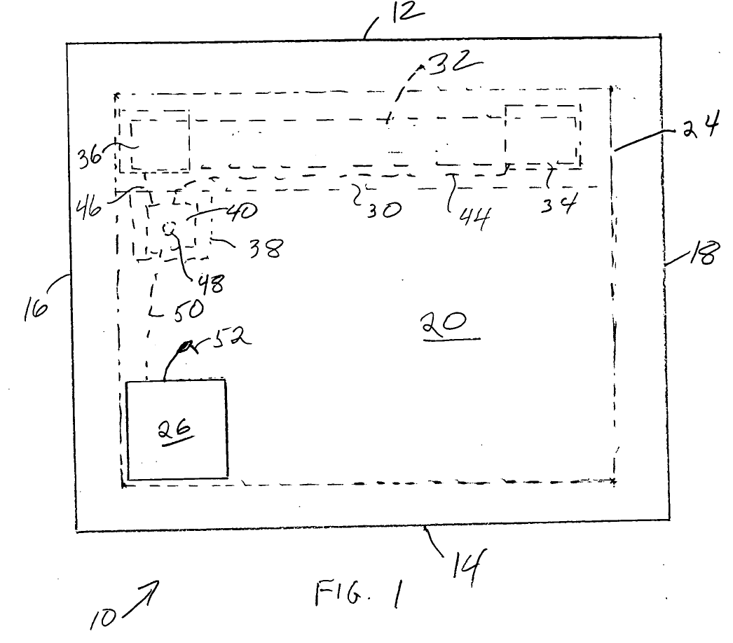

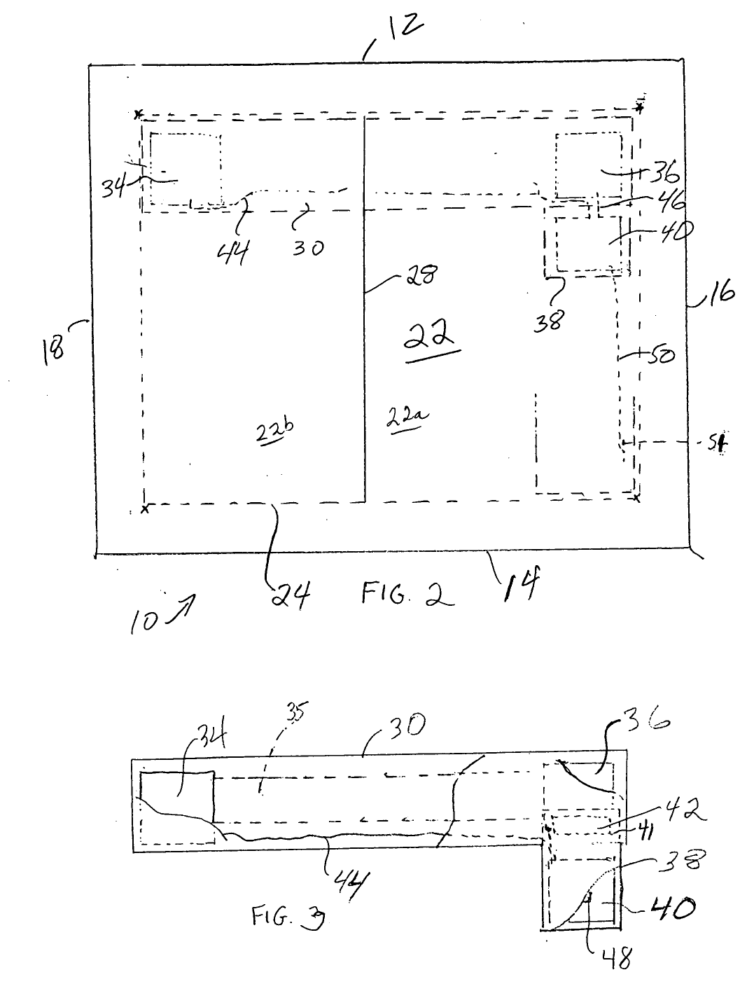

A speaker compartment 30, preferably made of cloth, extends from the seam near the edge 16 to the seam near the edge 18 just below the seam near the upper edge 12. The speaker compartment has VELCRO 35 (see FIG. 3) attached to an outside surface and running across preferably its entire length (including behind the speakers), and is held in place by VELCRO 32 (see FIG. 1) attached to the rear side of the front face 20 of the pillow sham 10. The speaker compartment 30 contains a left speaker 34 and a right speaker 36 (in relation to a user placing his/her head on the front of the pillow sham in a face-up position). The speakers may be fixed in the compartment 30 by sewing seams (not shown) in the compartment. An amplifier compartment or pocket 38 containing an amplifier 40 is mounted below the right speaker 36 and is either integral with the speaker compartment 30 or coupled to the speaker compartment 30 by sewing or other means. A flap 41 for the amplifier compartment is preferably provided with closure means such as VELCRO 42 on an inside face of a flap in order to close the flap onto a mating closure structure (not shown) on the compartment 30. Wires 44, 46 couple the speakers 34, 36 to the amplifier 40. The wires preferably run inside the speaker compartment 30 and the amplifier compartment 38, and where seams are used to fix the speakers in place in the compartment 30, openings are provided (i.e., the seams are gapped) to permit the wires to run therethrough. The amplifier 40 is provided with a pushbutton on-off switch 48 which can be activated by pushing on the top surface 20 of the pillow sham in the appropriate location. A wire 50 extends from the amplifier 40 down to and through a preferably sewn hole 51 in the front face 20 of the sham covered by the pocket 26 and terminates in an eighth inch mini-plug 52 which may be pulled out of the pocket as shown in FIG. 1.

From the foregoing, it will be appreciated that a pillow (not shown) may be placed in the sham 10, and that a personal stereo placed in the pocket 26 can be connected to the amplifier 40 by plugging the mini-plug 52 into the earphone jack of the stereo. Activation of the stereo and the amplifier will result in audio being produced by the left and right speakers 34 and 36. It will also be appreciated that when the pillow (not shown) is placed inside the pillow sham 10, the speakers and amplifier will preferably be located between the pillow and the top surface 20 of the sham. It will further be appreciated that the sham 10 and the speaker compartment 30 are dimensioned such that the speakers are located left of and right of an adult's head resting on the top surface 20 of the sham.

There have been described and illustrated herein embodiments of a pillow sham incorporating an amplifier and speakers. While particular embodiments of the invention have been described, it is not intended that the invention be limited thereto, as it is intended that the invention be as broad in scope as the art will allow and that the specification be read likewise. Thus, while the compartments for the speakers and the amplifier have been shown as separate from the pillow sham, they could be integral with the sham as long as the compartments may be opened with the provision of a zipper(s), buttons, VELCRO, or other opening/closing means such that the speakers and amplifier can be removed from the sham. In addition, while it is preferred that the speaker compartments be closed on all sides, it will be appreciated that they may be open on one or more sides. Thus, for example, one or both ends of the compartments may be open or partially open so that the speakers may be removed. Also, while it is preferred to have a separate compartments for the speakers and the amplifier, it will be appreciated that a single compartment could be provided. Moreover while the compartments have been shown to be rectangular, the compartments may take different shapes. Thus, for example, one speaker can be located in a first partially or totally enclosed compartment, another speaker can be located in a second partially or totally enclosed compartment, the amplifier can be located in the first, second, or a third partially or totally enclosed compartment, and the wires connecting the speakers and the amplifier may be sent through other compartments or tubes. Further, while particular dimensions have been disclosed for the pillow sham and the pocket, it will be appreciated that sham and/or pocket may take different dimensions. It will therefore be appreciated by those skilled in the art that yet other modifications could be made to the provided invention without deviating from its spirit and scope as claimed.

What is claimed is:

1. A pillow sham, comprising:
a generally rectangular enclosure having an upper edge, a lower edge, two side edges, a front sheet, and a back;
a compartment located in said enclosure;
at least one speaker located inside said compartment;
a pocket located on a first surface of said front sheet; and
a wire extending from said pocket, through said front sheet and to said compartment and coupled to said speaker.

2. A pillow sham according to claim 1, further comprising:
an amplifier coupled to said wire and the speaker.

3. A pillow sham according to claim 2, further comprising:
a mini-plug coupled to said wire.

4. A pillow sham according to claim 1, wherein:
said compartment is removably fixed in said enclosure.

5. A pillow sham according to claim 4, further comprising:
means for fixing said compartment to at least one of said front sheet and said back.

6. A pillow sham according to claim 5, wherein:
said means for fixing comprises a first element attached to a second surface of said front sheet, and a second element attached to said compartment.

7. A pillow sham according to claim 6, wherein:
said first element is a first VELCRO element, and said second element is a second VELCRO element.

8. A pillow sham according to claim 1, wherein:
said compartment is fixed to said front sheet, and
said compartment includes means for opening and closing said compartment to permit removal of said speaker therefrom.

9. A pillow sham according to claim 1, wherein:
said at least one speaker comprises two speakers, and
said pillow sham further comprises an amplifier coupled to said two speakers and to said wire.

10. A pillow sham according to claim 9, wherein:
said compartment comprises a single compartment housing said two speakers and said amplifier.

11. A pillow sham according to claim 9, wherein:
said compartment comprises a first compartment housing said two speakers and a second compartment housing said amplifier.

12. A pillow sham according to claim 11, wherein:
said second compartment is attached to said first compartment.

13. A pillow sham according to claim 12, wherein:
said second compartment has an opening for accessing said amplifier.

14. A pillow sham according to claim 13, wherein:
said second compartment has a flap means for closing said opening.

15. A pillow sham, comprising:
a generally rectangular enclosure having an upper edge, a lower edge, two side edges, a front, and a back;
at least one compartment attached to and within said enclosure;
two spaced apart speakers located inside the at least one compartment;
a pocket formed on an outside surface of said enclosure; and
a wire extending from the pocket, through said front or back, and into the compartment, said wire coupled to the speakers.

16. A pillow sham according to claim 15, further comprising:
an amplifier coupling said wire and said speakers.

17. A pillow sham according to claim 16, further comprising:
a stereo mini-plug coupled to said wire.

18. A pillow sham according to claim 15, wherein:
said compartment is removably fixed in said enclosure.

19. A pillow sham according to claim 18, further comprising:
means for fixing said compartment to at least one of said front and said back.

20. A pillow sham according to claim 19, wherein:
said means for fixing comprises a first element attached to an inside surface of said front, and a second element attached to said compartment.
